(19) United States
(12) Patent Application Publication
(10) Pub. No.: US 2021/0157384 A1
(43) Pub. Date: May 27, 2021

(54) ASSIGNING POWER SOURCES

(71) Applicant: Hewlett-Packard Development Company, L.P., Spring, TX (US)

(72) Inventors: Mark A. Piwonka, Spring, TX (US); Michael R. Durham, Spring, TX (US); Scott W. Sanders, Spring, TX (US); Javier Enrique Guerrero, Spring, TX (US); Binh T. Truong, Spring, TX (US)

(73) Assignee: Hewlett-Packard Development Company, L.P., Spring, TX (US)

(21) Appl. No.: 17/045,523

(22) PCT Filed: Jul. 20, 2018
(86) PCT No.: PCT/US2018/043050

§ 371 Date: Oct. 6, 2020

(51) Int. Cl. G06F 1/3209; G06F 9/4401; G06F 1/3296; G06F 13/42

(52) U.S. Cl. CPC G06F 1/3209; G06F 9/4418; G06F 2213/0042; G06F 13/4282; G06F 1/3296

(57) ABSTRACT

Example implementations relate to assigning power sources. An example system includes a network device and a computing device with a BIOS. The BIOS provides the network device a heartbeat in response to the computing device entering a hibernation state, assigns a power source to a network interface card (NIC) of the network device via a power delivery controller, and assigns the NIC to receive Wake-On-Lan (WOL) support. The system can place the computing device to a threshold power state responsive to the NIC receiving WOL support.

### BACKGROUND

Computer systems can shift between different power states. Computer systems can shift to some type of low power state when they are not in use. A computer system in a low power state can be woken up by an external wake-up event such as a mouse click, a key stroke, or a push of a button.

### BRIEF DESCRIPTION OF THE DRAWINGS

FIG. 1 illustrates an example system including a network device and a computing device according to the present disclosure.

FIG. 2 illustrates a block diagram of an example system according to the present disclosure.

FIG. 3 illustrates a block diagram of an example method according to the present disclosure.

### DETAILED DESCRIPTION

Computer systems have the capability to be woken up remotely over a network (e.g., by another computer system). Computer systems can include Basic Input Output System (BIOS), which is a non-volatile firmware used to perform hardware initialization during a booting process and/or power-on startup, and to provide runtime services for operating systems. In some instances, management components of BIOS options can be triggered to wake a computer up from hibernation or standby modes. For example, a BIOS can include Wake On Line (WOL) settings to wake computers up from a very low power mode remotely. However, Universal Serial Bus (USB) network devices may not have the capability to support WOL after a computer's power reset and/or power outage. This may be due to the limited capability to supply power to device over USB protocol after the computer system enters a hibernation state. USB network devices lacking the capability to support WOL can prevent remote image loading. In some instances, lacking the capability to support WOL can result in a main breaker being turned off to shut down an entire computer terminal.

In some examples of the present disclosure, computer systems can include a BIOS to support WOL using a USB charging port and USB power delivery (PD) controller technology after a computing system enters hibernation state. In some examples, a BIOS can power on the computer system to establish connection via a USB PD controller, and the BIOS can make a direct call using virtual wire and assign power source to a network interface card (NIC) of a network device. This can result in a smoother shutdown scenario as compared to other shutdown scenarios and provide an opportunity to write contents of computer memory to appropriate files. For instance, a computing device in a mechanically-off state can be placed to a threshold power state (“soft-off state”) by assigning a power source to a NIC. Prior to the computing device entering a mechanically-off state, the BIOS can provide a trigger to the computing device, assign a power source to the NIC of the network device, assign the NIC to receive WOL support, and place the computing device to a threshold power state in response to the NIC receiving WOL support.

Some approaches to wake up a computer system on a computer network include a network switching device coupled to a first and a second network link. The network switching devices determine whether a data unit, received at a first port of the first network link, includes data indicative of a wake-up event for the computer, and changes a state of a second network link to wake up the computer if the data unit includes data indicative of the wake-up event for the computer. However, these approaches do not address assign a NIC to receive WOL support and place the computing device to a threshold power state in response to the NIC receiving WOL support. While some approaches include methods to control standby power using an Ethernet controller, these approaches still do not address assigning USB NIC to receive WOL support when the system enters soft-off-state.

Accordantly, the present disclosure is directed to a power source assignments system. For example, a system can include a network device coupled to a computing device, and the computing device can have a BIOS. As described herein, as a computer device enters a hibernation state, the BIOS can provide the network device a heartbeat. As used herein, the term, “hibernation state” refers to a power saving state. In a hibernation state, the computer can use the same amount of power as a computer that is shut down. In some examples, in response to the network device receiving a heartbeat, a BIOS can assign a power source to a NIC via a power delivery controller. As described herein the term “heartbeat” refers to a periodic signal generated by computer hardware and/or software to indicate normal operation, connectivity accuracy, and functional accuracy. A heartbeat event can be generated in response to frequency pulses and by light emitting diode (LED).

A heartbeat event can indicate network connectivity installation accuracy of a system. For example, a system LED can receive a heartbeat signal indicating that the system is installed correctly, and the power is on. The heartbeat signal can be transmitted in response to the LED light indicating a solid green light. In some examples, heartbeat response can be transmitted in response to the LED light being turned off, indicating that the system is not installed properly.

In some examples, a heartbeat event can indicate a system is running correctly. For example, a system including a LED can receive a heartbeat signal in response to the system being installed. The heartbeat event can be transmitted in response to the LED light turning green and blinking rapidly. In some examples, the system can receive a heartbeat event in response to completing initialization sequence. The heartbeat event can be transmitted in response to LED light turning green, and pulsing on and off. In some examples, the system can receive a heartbeat event in response to an error in the system. The heartbeat event can be transmitted in response to the LED light turning red or amber. While red, green, and amber colors are discussed herein, other indicators (color, patterns, etc.) may be used.

In some examples, a computer system can generate heartbeat event every fifteen minutes to indicate normal operations. In some examples, the computer system can generate a heartbeat event every five minutes to indicate that all parts of the computer system are not synchronized. In some examples, the computer system can generate a heartbeat event every minute to indicate that the system has lower than average power supply and/or entering a sleeping state.

In some examples, the NIC receives WOL support in response to the hibernation state of the computing device and the computing device is placed in a threshold power state responsive to the NIC receiving WOL support.

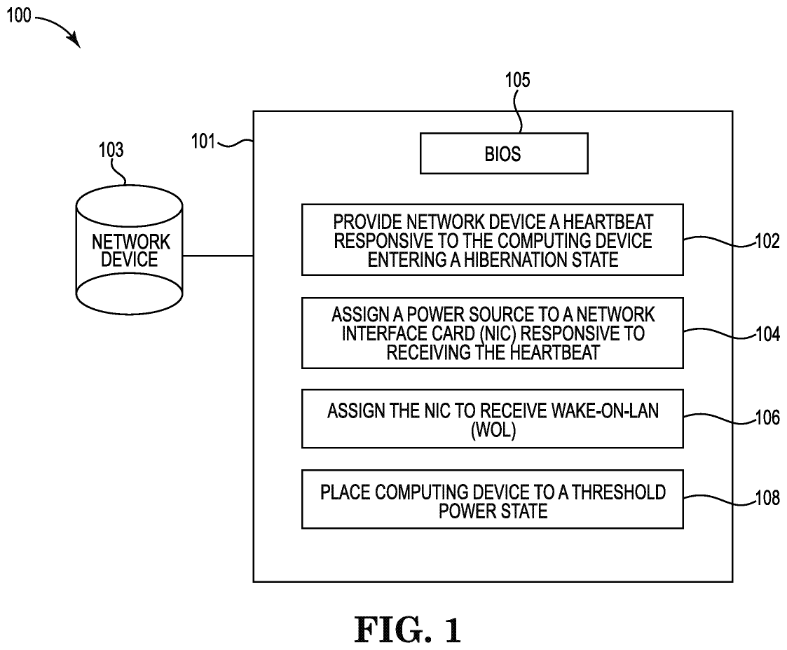

FIG. 1 illustrates an example system 100 including a network device 103 and a computing device 101, according to the disclosure. Computing device 101 can include a BIOS 105. The BIOS 105 can manage data flow including instructions 102, 104, 106, and 108. The computing device 101 can be placed in a threshold power state in response to the BIOS 105 providing and assigning instructions 102, 104, 106, and 108, as described herein.

The computing device 101 can be a combination of hardware and program instructions configured to share information. The hardware, for example, can include a processing resource and/or a memory resource (e.g., computer readable medium (CRM), machine readable medium, database, etc.). The instructions can include, for instance, instructions 102, 104, 106, and 108 to perform desired functions.

The network device 103 can be a connectivity device to connect computers and/or other electronic devices. The network device 103 can include a variety of conventional network topologies and types (including optical, wired and/or wireless networks), employing any of a variety of conventional network protocols (including public and/or proprietary protocols). Network device 103 can include, gateways, routers, network bridges, modems, wireless access points, networking cables, line drivers, switches, hubs, and repeaters, among other things. In some examples, networking device 103 can include hybrid multilayer devices (e.g., switches, protocol converters, bridge routers, proxy servers, firewalls). In some examples, system 100 can include network device 103 coupled to the computing device 101.

In some examples, BIOS 105 can be implemented in computing device 101 to start system 100. At 102, BIOS 105 can detect a heartbeat event in response to system 100 entering a hibernation state. In some examples, the BIOS 105 can detect the heartbeat event in response to detecting a change in hardware such as an addition of an external memory (e.g., USB flash drive, external hard drive, etc.). In some examples, the BIOS 105 can detect the heartbeat event in response to a network cable being connected to a router and/or a network switch and indicates a detected LED link. In some examples, the BIOS 105 can detect the heartbeat event in response to the network device 103 streaming or being accessed, and LED light indicates an activity.

In some examples, the hibernation state includes a mechanically-off state. A mechanically-off state can include system 100 in a sleeping state. In some examples, the hibernation state can include the processor and some chips on the motherboard being off. In some examples, the hibernation state can include a loss of Central Processing Unit (CPU) context, cache contents, and chipset context.

At 104, BIOS 105 can assign a power source to a NIC of the network device 103. The power source can be assigned via a power delivery controller in response to the network device 103 receiving the heartbeat. As described herein, the term “network interface card” or “NIC” refers to an electronic circuitry used to communicate via a wired connection (e.g., Ethernet) or a wireless connection (e.g., WiFi). In some examples, the NIC can be a network interface controller. In some examples, the NIC can include a network adapter, and/or a local Area Network (LAN) Adapter, among other network adapters. In some examples, the NIC can receive a WOL message.

At 106, BIOS 105 can assign the NIC of the network device 103 to receive WOL message in response to detection of the computing device 101 in the hibernation state. In some example, the WOL can be received using a magic packet to awaken the computing device 101. The magic packet can contain an identifying number built into the NIC. In some examples, a unique identifier such as a Media Access Control (MAC) address of the magic packet can enable it to be uniquely recognized and addressed on a network device 103. In some examples, computer device 101 with WOL capability can listen to incoming packets in low-power mode while the system 100 is in hibernation state. In some examples, the NIC of the network device 103 can signal computer device 101's power supply and/or motherboard to initiate system wake-up, in the same way that pressing the power button would.

In some examples, the BIOS 105 can assign a power source in the hibernation state via a virtual wire. In some examples, virtual wire can pass packets transparently. In some examples, the virtual wire can support blocking or allowing traffic based on virtual LAN (ULAN) tags, in addition to supporting security policy rules, content identification (ID), and decryption, among other things.

In some examples, BIOS 105 can make a direct call by sending virtual wire to receive information. In some examples, the BIOS 105 can make a direct call via the power delivery controller in response to a Universal Serial Bus (USB) power delivery controller establishing a connection via the virtual wire and the NIC of the network device 103. USB power delivery controller can include a Type C connector. In some examples, the Type C connector can alternate or customize communication standards among computing application platforms (e.g., mobile, wearable, accessories, and internet of things (IoT)).

In some examples, BIOS 105 can manage data flow on other participant computer devices, on a server device, on a collection of server devices, and/or on a combination of the user device and the server device. For instance, if a computing system is running, and there is a power state event (e.g., turning off, sleep, etc.), the BIOS 105 can detect the event. In some examples, the BIOS 105 can detect a change in hardware, for instance, the addition of an external memory device (e.g., USB flash drive, external hard drive, etc.).

In some examples, the BIOS 105 can send an event to arrange an NIC Option Read Only memory (option ROM) to support the WOL. Option ROM can include software that is called by the BIOS 105. In some examples, the BIOS 105 can make calls via a virtual wire to the PD controller. In response, the PD controller can assign the network device 103 to trigger the heartbeat event. In some examples, an option ROM can be a video BIOS of a graphic card, and/or the option ROM can be a network boot ROM that allows a computer system without disks or persistent storage to run an operating system by downloading the necessary software over the network. For example, the BIOS 105 can send an event to arrange an NIC option ROM to support WOL in response to computer system 101 lacking storage.

BIOS 105 can send an event to arrange a NIC option ROM to support the WOL. In some examples, the NIC option ROM may not detect the system 101 in hibernation state. In response to the BIOS 105 sending an event, as described herein, the NIC option ROM can determine the system 101's setting to support WOL.

At 108, BIOS 105 can place the computing device 101 to a threshold power state in response to the NIC receiving WOL support. In some examples, the threshold can include a low power state or soft-off state. In some examples, threshold state can be a full shutdown of the computing device 101.

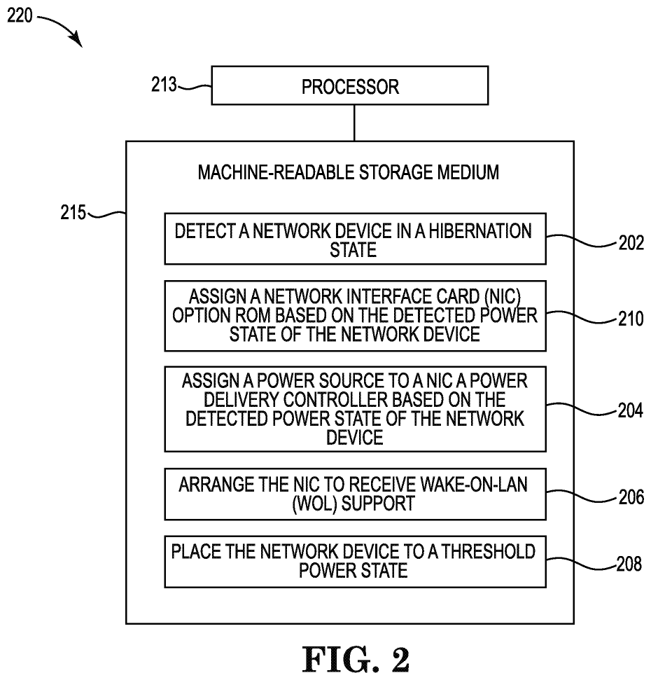

FIG. 2 illustrates a block diagram of an example system 220 according to the present disclosure. In the particular example shown in FIG. 2, system 220 includes a processor 213 and a machine-readable storage medium 215. The machine-readable storage medium 215 can be a non-transitory machine-readable storage medium. Machine-readable storage medium 215 can include instructions 202, 210, 204, 206, and 208 that, when executed via processor 213, perform detecting, assigning, arranging, and placing functions. Although the following descriptions refer to an individual processor and an individual machine-readable storage medium, the descriptions can also apply to a system with multiple processing resources and multiple machine-readable storage mediums. In such examples, the instructions can be distributed across multiple machine-readable storage mediums and the instructions can be distributed across multiple processing resources. Put another way, the instructions can be stored across multiple machine-readable storage mediums and executed across multiple processing resources, such as in a distributed computing environment.

Processor 213 can be a CPU, microprocessor, and/or other hardware device suitable for retrieval and execution of instructions stored in machine-readable storage medium 215. In the particular example shown in FIG. 2, processor 213 can execute instructions to detect, assign, arrange, and place instructions 202, 210, 204, 206, and 208. As an alternative to or in addition to retrieving and executing instructions, processor 213 can include an electronic circuit comprising a number of electronic components for performing the operations of the instructions in machine-readable storage medium 215. With respect to the executable instruction representations or boxes described and shown herein, it should be understood that part or all of the executable instructions and/or electronic circuits included within one box can be included in a different box shown in the figures or in a different box not shown.

Machine-readable storage medium 215 may be any electronic, magnetic, optical, or other physical storage device that stores executable instructions. Thus, machine readable storage medium 215 may be, for example, Random Access Memory (RAM), an Electrically-Erasable Programmable Read-Only Memory (EEPROM), a storage drive, an optical disc, and the like. The executable instructions may be installed on the system 220 illustrated in FIG. 2. Machine-readable storage medium 215 may be a portable, external or remote storage medium, for example, that allows the system 220 to download the instructions from the portable/external/remote storage medium. In this situation, the executable instructions may be part of an “installation package”. As described herein, machine-readable storage medium 215 may be encoded with executable instructions related placing the network device to a threshold power state by arranging a NIC to receive WOL support.

System 220 can include instructions 202 that when executed by the processor 213 can detect, via a BIOS of the computing system 220, a network device in a hibernation state. In some examples, system 220 can have a BIOS as a firmware. The BIOS can detect the network device in a hibernation state when the system 220 is in a power saving state. In some examples, instructions 202 can be executed to detect network in hibernation state in response to the system being powered off.

System 220 can include instructions 210. Instructions 210, when executed by the processor 213, can assign a NIC option ROM based on the detected power state of the network device. NIC option ROM can include firmware that is called by the BIOS. In some examples, the NIC option ROM can be a video BIOS of a graphic card. In some examples, NIC option ROM can be a network boot ROM. In some examples, instructions 210 can be executed to arrange the NIC option ROM to support WOL in response to system 220 lacking storage. In some examples, instructions 210 can be executed to assign a USB NIC to receive WOL support. In some example the WOL support is received via an ethernet packet. The ethernet packet can include data enclosed in one or more wrappers that help identify data and route the data to an application and/or process, for example, WOL.

System 220 can include instructions 204 that when executed by the processor 213 can assign a power source to a NIC of the network device via a power delivery controller based on the detected power state of the network device. For example, instructions 204 can be executed to assign the NIC of the network device a power source using a power delivery controller based on the a low power state of the network device. In some examples, instructions 204 can be executed by processor 213 for the BIOS to place a direct call via the power delivery controller in response to a USB power delivery controller establishing a connection between a virtual wire and the MC of the network device.

System 220 can include instructions 206. Instructions 206, when executed by the processor 213, can arrange the MC to receive WOL support in response to the detection of the computing system in a hibernation state. In some examples, system 220 can receive a magic packet in response to detecting the hibernation state, and in some examples, instructions 206 can be executed to direct the magic packet NIC to receive WOL by signaling the computer's power supply or motherboard to initiate system wake-up in the same way that pressing the power button would do.

System 220 can include instructions 208 that when executed by the processor 213 can place the network device to a threshold power state in response to the NIC receiving WOL support. In some examples, the threshold power can be the smallest amount of power state needed to to wake up the computing system. In some examples, BIOS can send a command to set a system to enter a threshold or low power state. In some examples, the BIOS can control when to send the event during post environment to allow the network device to retain power and assign the network device to obtain an active network link before assigning it to a threshold power state.

In some examples, upon detecting a hibernation state, BIOS can include a menu option including options such as, “Power Off” (to disable USB WOL support), “Power On”, “Previous state” (auto Enable USB NIC WOL support if prior state is Off), and “Power Off” (Enabled USB NIC for WOL support).

In some examples, system 220 can include instructions executable by processor 213 to power on the computing system via an Advanced Configuration and Power Interface (ACPI) call. In some instances, an ACPI can provide open standard for systems, such as for system 100, illustrated in FIG. 1, to discover and assign power sources. In some examples, an ACPI call can perform power management by putting unused components to sleep, and by performing status monitoring.

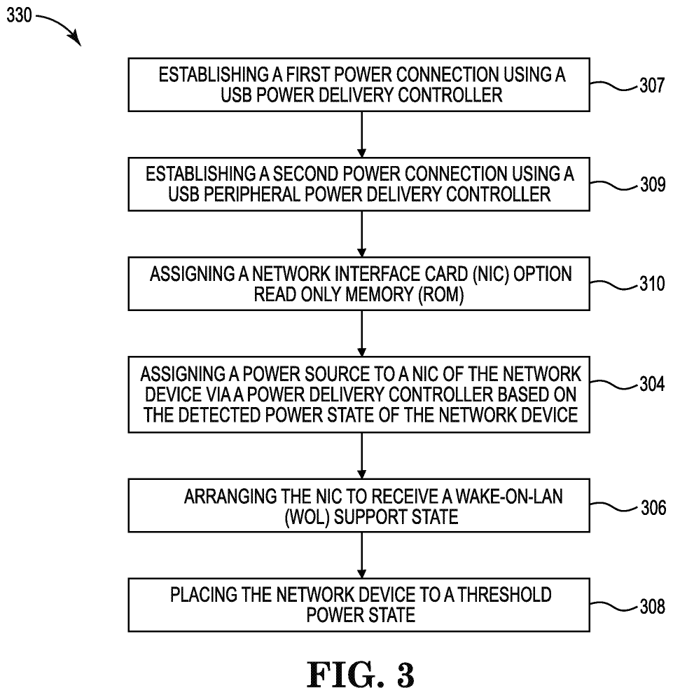

FIG. 3 illustrates a diagram of an example method 330 according to the present disclosure. In some examples, method 330 can be performed with a system, such as system 100 illustrated in FIG. 1. In some examples, a system can include a computing device and/or controller that includes instructions to be executed to perform the method 330.

At 307, method 330 can include establishing a first power connection using a USB platform power delivery controller. In some examples, the USB platform power delivery controller can establish connection with the BIOS. In some examples, the platform power delivery controller can act as a power resource passthrough. In some examples, the USB platform power delivery controller can be a source to set up power state.

At 309, method 330 can include establishing a second power connection using a USB peripheral power delivery controller. In some examples, the USB peripheral power platform controller can establish connection with the USB platform power delivery controller. In some examples, the USB peripheral power delivery controller can support the power delivery policy engine and communicate with the USB platform power delivery controller via host interface. In some examples, the USB peripheral power controller can be a sync end. In some instances, a system, such as system 100 illustrated in FIG. 1, can include a USB platform power delivery controller, and a USB peripheral power delivery controller to determine the source end and the syn end and assign power sources accordingly. In response, the BIOS in the system can receive power feeding from the a USB platform power delivery controller and set the system at a threshold state.

At 310, method 330 can include assigning a NIC option ROM based on the detected power state of the network device. In some examples the BIOS can send an event to arrange an NIC option ROM to support WOL in response to computer system lacking storage.

At 304, method 330 can include assigning a power source to a NIC of the network device via a power delivery controller based on the detected power state of the network device. For example, at 304, method 330 can include assigning a NIC of the network device a power source to execute fast start using a power delivery controller based on the detected power state of the network device. In some examples, at 304, method 330 can include the BIOS placing a direct call via the power delivery controller in response to a USB power delivery controller establishing a connection between a virtual wire and the NIC of the network device.

At 306, method 330 can include arranging the NIC to receive WOL support responsive to the detection of the computing system in a hibernation state. In some examples, method 330 can include detecting the network device in the hibernation state by using a BIOS menu. In some example the BIOS menu can include entries such as disable USB WOL support, power on, auto Enable USB NIC WOL support if prior state is Off, and Enabled USB Nic for WOL support. In some examples, Enabled USB NIC for WOL support (during power Off setting) is selected for method 330 to detect the network device in hibernation state.

At 308, method 330 can include placing the network device to a threshold power state responsive to the NIC receiving WOL support. Threshold power state can change the power state of the power source to wake up the computing system. In some examples, BIOS can send a command to set a system such as system 220 describe with respect to FIG. 2 to enter a threshold or low power state. In some examples, the BIOS can control when to send the event during post environment to allow the network device to retain power and assign the network device to obtain an active network link before assigning it to a threshold power state.

In the foregoing detailed description of the disclosure, reference is made to the accompanying drawings that form a part hereof, and in which is shown by way of illustration how examples of the disclosure may be practiced. These examples are described in sufficient detail to enable those of ordinary skill in the art to practice the examples of this disclosure, and it is to be understood that other examples may be utilized and that process, electrical, and/or structural changes may be made without departing from the scope of the disclosure. As used herein, designators such as “N”, etc., particularly with respect to reference numerals in the drawings, indicate that a number of the particular feature so designated can be included. A “plurality of” is intended to refer to more than one of such things.

What is claimed is:

1. A system, comprising:
a network device coupled to a computing device; and
the computing device having a basic input/output system (BIOS) to:
provide the network device a heartbeat responsive to the computing device entering a hibernation state;
assign a power source to a network interface card (NIC) of the network device via a power delivery controller responsive to the network device receiving the heartbeat;
assign the NIC to receive Wake-On-Lan (WOL) support responsive to detection of the computing device in the hibernation state; and
place the computing device to a threshold power state responsive to the NIC receiving WOL support.

2. The system of claim 1, comprising the heartbeat to provide an active network Light Emitting Diode (LED) link.

3. The system of claim 1, wherein the hibernation state comprises a mechanically-off state.

4. The system of claim 1, comprising the BIOS to assign the power source in the hibernation state via a virtual wire.

5. The system of claim 4, further comprising the BIOS to make a direct call via the power delivery controller in response to a Universal Serial Bus (USB) power delivery controller establishing a connection via the virtual wire and the NIC of the network device.

6. The system of claim 1, wherein the threshold state comprises a low power state or soft-off state.

7. The system of claim 1, further comprising the BIOS to send an event to arrange an NIC Option Read Only memory (ROM) to the WOL support.

8. A non-transitory machine-readable medium storing instructions executable by a processor to cause a computing system to:
detect, via a basic input/output system (BIOS) of the computing system, a network device in a hibernation state;
assign a network interface card (NIC) Option Read Only Memory (ROM) based on the detected power state of the network device;
assign a power source to a NIC of the network device via a power delivery controller based on the detected power state of the network device:
arrange the NIC to receive Wake-On-Lan (WOL) support responsive to the detection of the computing system in a hibernation state; and
place the network device to a threshold power state responsive to the NIC receiving WOL support.

9. The medium of claim 8, comprising instructions executable by the processor to detect the network device in the hibernation state responsive to the system powering off.

10. The medium of claim 8, comprising instructions executable by the processor to place the network device to the threshold power state by changing the power state to wake up the computing system.

11. The medium of claim 8, comprising instructions executable by a processor to power on the computing system via an Advanced Configuration and Power Interface (ACPI) call.

12. The medium of claim 8, comprising instructions executable by the processor to assign a Universal Serial Bus (USB) NIC to receive WOL support via an ethernet packet.

13. The medium of claim 8, comprising instructions executable by the processor to send a signal to the BIOS, wherein the BIOS assigns the network device to receive an active network link prior to placing the network device to the threshold power state.

14. A method, comprising:
detecting, via a basic input/output system (BIOS) of the computing system, a network device in a hibernation state;
establishing a first power connection using a Universal Serial Bus (USB) platform power delivery controller;
establishing a second power connection using a USB peripheral power delivery controller;
assigning a network interface card (NIC) Option Read Only Memory (ROM) based on the detected power state of the network device;
assigning a power source to a NIC of the network device via a power delivery controller based on the detected power state of the network device;
arranging the NIC to receive a Wake-On-Lan (WOL) support state responsive to the detection of the computing system in a hibernation state; and
placing the network device to a threshold power state responsive to the NIC receiving WOL support.

15. The method of claim 14, further comprising detecting the network device in the hibernation state by using a BIOS menu, wherein the BIOS menu comprises disable USB WOL support, power on, auto Enable USB NIC WOL support if prior state is Off, and Enabled USB NIC for WOL support.
